(19) United States
(12) Patent Application Publication
(10) Pub. No.: US 2023/0337265 A1
(43) Pub. Date: Oct. 19, 2023

(54) TARGET WAKE TIME OPERATION FOR ENHANCED MULTI-LINK MULTI-RADIO OPERATION

(71) Applicant: Samsung Electronics Co., Ltd., Suwon-si (KR)

(72) Inventors: Rubayet Shafin, Allen, TX (US); Boon Loong Ng, Plano, TX (US); Peshal Nayak, Plano, TX (US)

(21) Appl. No.: 18/295,807

(22) Filed: Apr. 4, 2023

Related U.S. Application Data
(60) Provisional application No. 63/331,103, filed on Apr. 14, 2022.

(51) Int. Cl. H04W 72/51; H04W 52/02

(52) U.S. Cl. CPC H04W 72/51; H04W 52/0206; H04W 52/0216

(57) ABSTRACT

Methods and apparatuses for supporting target wake time operation for enhanced multi-link multi-radio operation. A method for wireless communication performed by a non-access point (AP) multi-link device (MLD) that comprises stations (STAs), the method comprising: forming a first enhanced multi-link multi-radio (EMLMR) link for an EMLMR mode of operation with a first AP of an AP MLD; forming a second EMLMR link for the EMLMR mode of operation with a second AP of the AP MLD; establishing a first restricted target wake time (r-TWT) schedule that has an r-TWT service period (SP) is established on the first EMLMR link; determining that the non-AP MLD is operating in the EMLMR mode of operation with the AP MLD; and determining, based on the r-TWT SP, scheduling for traffic on the first EMLMR link and the second EMLMR link.

### CROSS-REFERENCE TO RELATED APPLICATION AND CLAIM OF PRIORITY

This application claims priority under 35 U.S.C. § 119(e) to U.S. Provisional Patent Application No. 63/331,103 filed on Apr. 14, 2023, which is hereby incorporated by reference in its entirety.

### TECHNICAL FIELD

This disclosure relates generally to transmission efficiency in wireless communications systems that include multi-link devices. Embodiments of this disclosure relate to methods and apparatuses for supporting target wake time operation for enhanced multi-link multi-radio operation.

### BACKGROUND

Wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Multi-link operation (MLO) is a feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-access point (AP) multi-link device (MLD) to discover, authenticate, associate, and set up multiple links with an AP MLD. Channel access and frame exchange is possible on each link between the AP MLD and non-AP MLD.

### SUMMARY

Embodiments of the present disclosure provide methods and apparatuses for supporting target wake time operation for enhanced multi-link multi-radio operation.

In one embodiment, a non-AP MLD is provided, comprising: stations (STAs) comprising transceivers, respectively, a first of the STAs configured to form a first enhanced multi-link multi-radio (EMLMR) link for an EMLMR mode of operation with a first AP of an AP MLD, and a second of the STAs configured to form a second EMLMR link for the EMLMR mode of operation with a second AP of the AP MLD, wherein a first restricted target wake time (r-TWT) schedule that has an r-TWT service period (SP) is established on the first EMLMR link. The non-AP MLD includes a processor operably coupled to the transceivers, the processor configured to: determine that the non-AP MLD is operating in the EMLMR mode of operation with the AP MLD, and based on the first r-TWT SP, determine scheduling for traffic on the first EMLMR link and the second EMLMR link.

In another embodiment, an AP MLD is provided, comprising: AP's comprising transceivers, respectively, a first of the APs configured to form a first EMLMR link for an EMLMR mode of operation with a first STA of a non-AP MLD, and a second of the APs configured to form a second EMLMR link for the EMLMR mode of operation with a second STA of the AP MLD, wherein a first r-TWT schedule that has an r-TWT SP is established on the first EMLMR link. The AP MLD includes a processor operably coupled to the transceivers, the processor configured to: determine that the AP MLD is operating in the EMLMR mode of operation with the non-AP MLD, and based on the first r-TWT SP, determine scheduling for traffic on the first EMLMR link and the second EMLMR link.

In yet another embodiment, a method of wireless communication performed by a non-AP MLD is provided. The method comprises: A method for wireless communication performed by a non-AP MLD that comprises STAs, the method comprising: forming a first EMLMR link for an EMLMR mode of operation with a first AP of an AP MLD; forming a second EMLMR link for the EMLMR mode of operation with a second AP of the AP MLD; establishing a first r-TWT schedule that has an r-TWT SP is established on the first EMLMR link; determining that the non-AP MLD is operating in the EMLMR mode of operation with the AP MLD; and determining, based on the first r-TWT SP, scheduling for traffic on the first EMLMR link and the second EMLMR link.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example station (STA) according to various embodiments of the present disclosure;

FIG. 3 illustrates the use of an enhanced multi-link (EML) Operating Mode Notification frame to transition into an EML single-radio (EMLSR) mode of operation according to embodiments of the present disclosure;

FIG. 4 illustrates an example of a procedure for an EML multi-radio (EMLMR) mode of operation according to embodiments of the present disclosure;

FIG. 5 illustrates an example of ending a transmission opportunity (TXOP) on an EMLMR link before a restricted target wake time service period (r-TWT SP) starts on another EMLMR link according to embodiments of the present disclosure;

FIG. 6 illustrates an example of ending TXOP on an EMLMR link an EMLMR delay amount of time before the r-TWT SP starts on another EMLMR link according to embodiments of the present disclosure;

FIG. 7 illustrates an example of frame transmission with EMLMR operation during r-TWT SP without the need for initial control frame (ICF) transmission according to embodiments of the present disclosure;

FIG. 8 illustrates an example of avoiding EMLMR initial frame transmission on a link due to too short of TWT SP remaining according to embodiments of the present disclosure;

FIG. 9 illustrates an example of the continuation of TXOP on an EMLMR link (Link 2) while another EMLMR link (Link 1) has an r-TWT SP that overlaps in time with the TXOP, where the TIDs negotiated for the r-TWT SP on Link 1 are also mapped on Link 2 according to embodiments of the present disclosure;

FIG. 10 illustrates an example of disabling the EMLMR mode before overlapping r-TWT SP according to embodiments of the present disclosure;

FIG. 11 illustrates another example of disabling the EMLMR mode before overlapping r-TWT SP according to embodiments of the present disclosure;

FIG. 12 illustrates an example of r-TWT SP prioritization based on broadcast TWT ID during the EMLMR mode of operation according to embodiments of the present disclosure;

FIG. 13 illustrates a flowchart of EMLMR operation with multiple r-TWT schedules established on multiple EMLMR links according to embodiments of the present disclosure; and

FIG. 14 illustrates a flowchart of a method for wireless communication performed by a non-AP MLD according to embodiments of the present disclosure.

### DETAILED DESCRIPTION

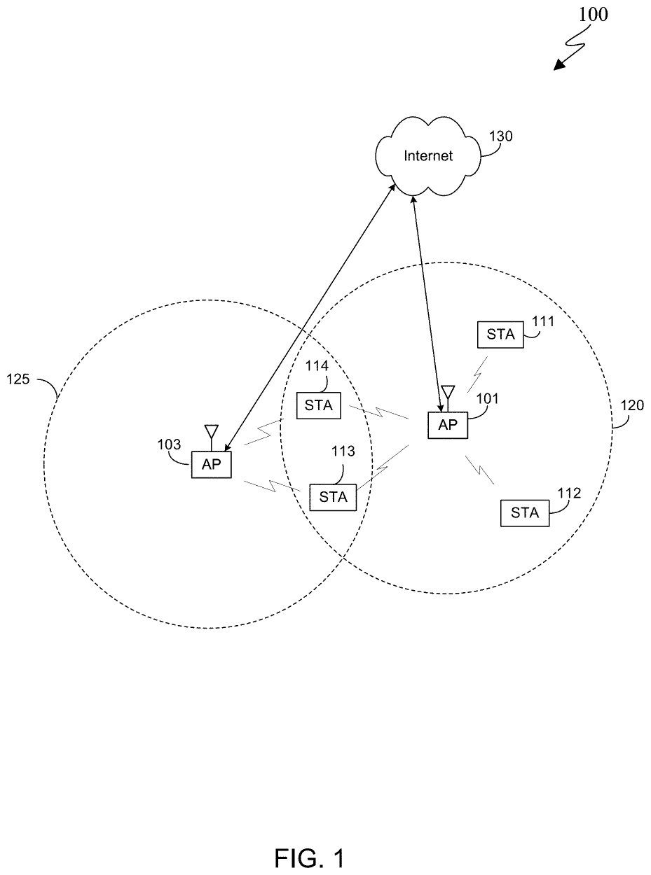

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure provide mechanisms for supporting target wake time operation for enhanced multi-link multi-radio operation.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for supporting target wake time operation for enhanced multi-link multi-radio operation. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

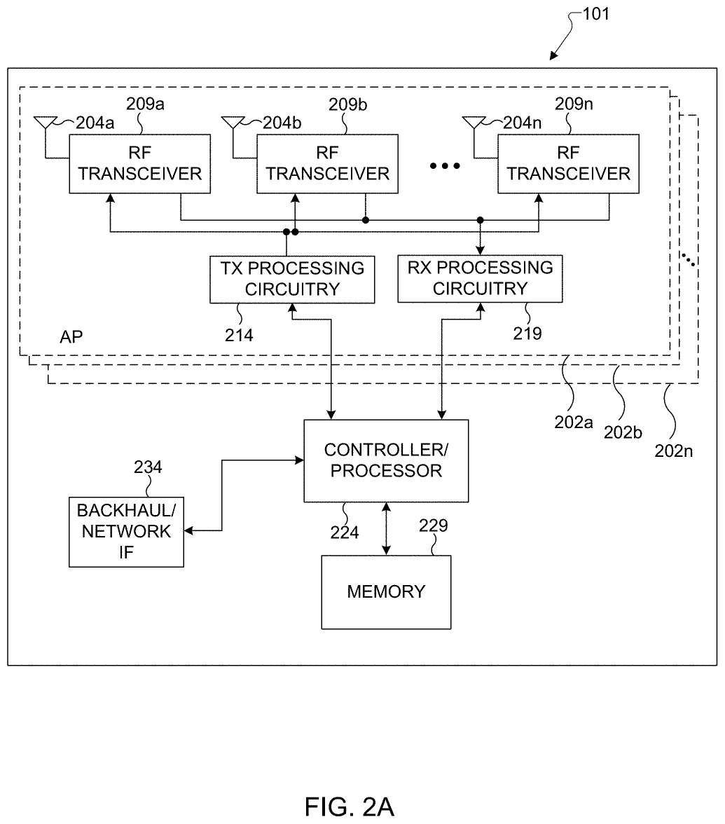

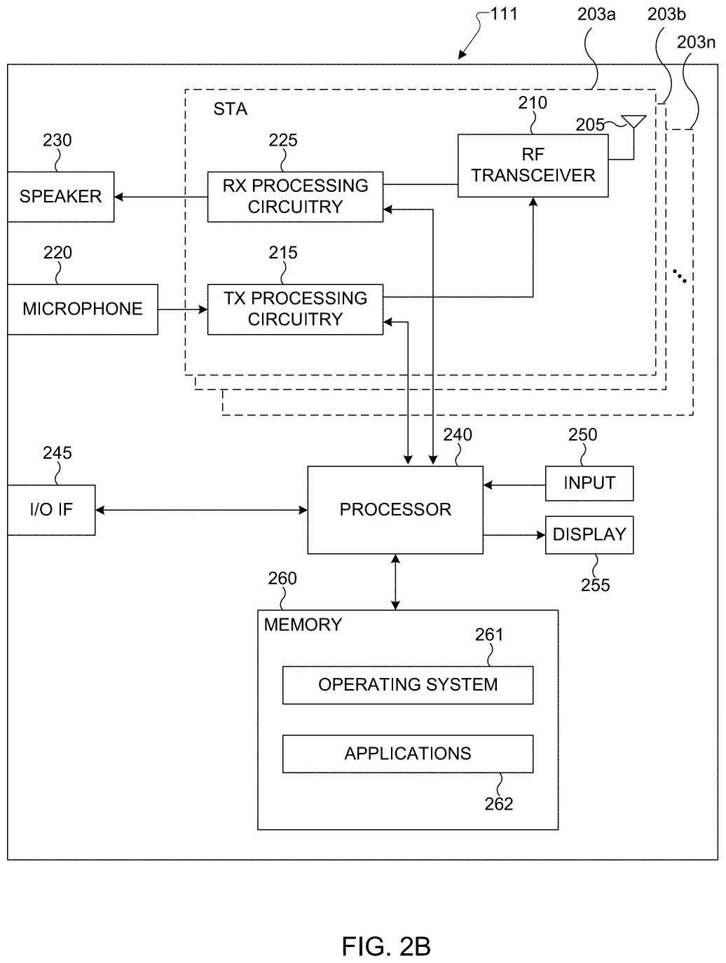

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including supporting target wake time operation for enhanced multi-link multi-radio operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for supporting target wake time operation for enhanced multi-link multi-radio operation. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to support target wake time operation for enhanced multi-link multi-radio operation. In some embodiments, the controller/processor 240 includes at least one microprocessor or microcontroller.

The controller/processor 240 is also capable of executing other processes and programs resident in the memory 260, such as operations for supporting target wake time operation for enhanced multi-link multi-radio operation. The controller/processor 240 can move data into or out of the memory 260 as required by an executing process. In some embodiments, the controller/processor 240 is configured to execute a plurality of applications 262, such as applications for supporting target wake time operation for enhanced multi-link multi-radio operation. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

The non-AP MLDs in 802.11be can have different capabilities in terms of multi-link operation. The current 802.11be specification defines two special kinds of multi-link operations, namely, Enhanced Multi-Link Single-Radio Operation (EMLSR) and Enhanced Multi-Link Multi-Radio Operation (EMLMR).

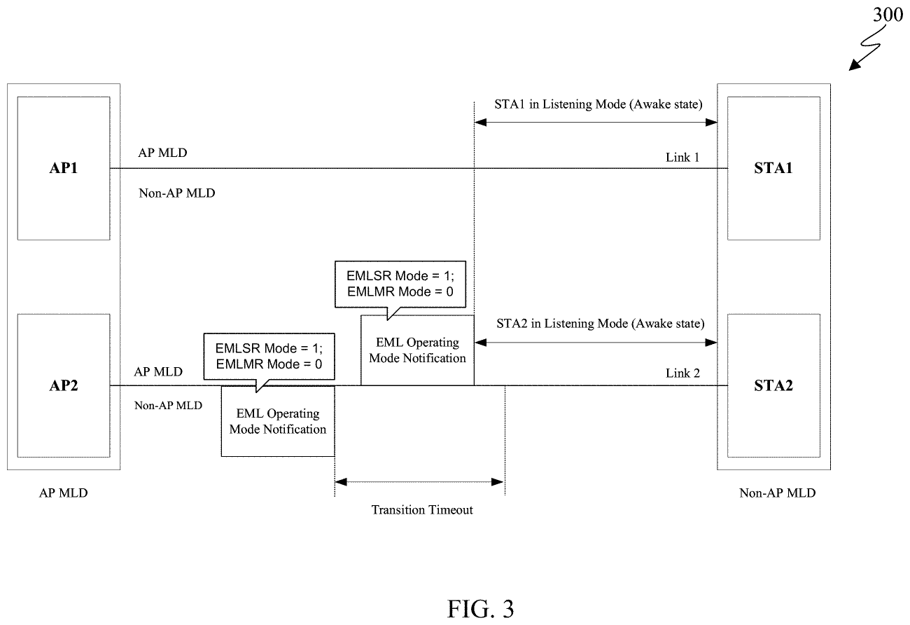

Many 802.11be non-AP MLDs may only have a single radio. Enhanced Multi-Link Single Radio (EMLSR) enables a multi-link operation with a single radio. With EMLSR operation, a non-AP MLD can achieve throughput enhancement with reduced latency—a performance close to concurrent dual radio non-AP MLDs. EMLSR operation and the behavior of STAs affiliated with non-AP MLD during EMLSR mode of operation are defined in 802.11be standards. According to current specifications, if a non-AP MLD intends to operate in EMLSR mode with its associated AP MLD, a STA affiliated with the non-AP MLD sends an EML Operating Mode Notification frame to its associated AP affiliated with the AP MLD, where the EMLSR Mode subfield in EML Control field in the EML Operating Mode Notification frame is set to 1. Upon receiving the EML Operating Mode Notification frame from the non-AP MLD, the AP MLD can send, on any enabled link between the AP MLD and the non-AP MLD, another EML Operating Mode Notification frame, where the EMLSR Mode subfield in EML Control field in the EML Operating Mode Notification frame is set to 1. The AP affiliated with the AP MLD is expected to send the EML Operating Mode Notification frame in response to the EML Operating Mode Notification frame sent by an STA affiliated with the non-AP MLD within the timeout interval indicated in the Transition Timeout subfield in EML Capabilities subfield in the Basic Variant Multi-Link element that is most recently exchanged between the AP MLD and the non-AP MLD. The non-AP MLD transitions to EMLSR mode immediately after receiving the EML Operating Mode Notification frame with EMLSR Mode subfield in EML Control field set to 1 from an AP affiliated with the AP MLD or immediately after the timeout interval indicated in the Transition Timeout subfield in EML Capabilities field in the Basic Variant Multi-Link element elapses after the end of last PPDU contained in the EML Operating Mode Notification frame transmitted by the non-AP MLD, whichever occurs first. Upon transitioning into EMLSR mode of operation, all STAs affiliated with the non-AP MLD transition to active mode (listening mode). This process for transitioning into EMLSR mode using the EML Operating Mode Notification frame exchanges is illustrated in FIG. 3.

FIG. 3 illustrates the use of an EML Operating Mode Notification frame to transition into EMLSR mode 300 according to embodiments of the present disclosure. The embodiment of the use of an EML Operating Mode Notification frame to transition into EMLSR mode 300 shown in FIG. 3 is for illustration only. Other embodiments of the use of an EML Operating Mode Notification frame to transition into EMLSR mode 300 could be used without departing from the scope of this disclosure.

As illustrated in FIGS. 3, AP1 and AP2 are two APs affiliated with the AP MLD. Also, STA1 and STA2 are two non-AP STAs affiliated with the non-AP MLD. Two links are set up between the AP MLD and the non-AP MLD—Link 1 between AP1 and STA1, and Link 2 between AP2 and STA2. Moreover, in this illustration, both Link 1 and Link 2 are enabled links. The non-AP MLD intends to transition to the EMLSR mode, and accordingly, STA2 sends to AP2 over Link 2 an EML Operating Mode Notification frame with the EMLSR Mode subfield in EML Control field set to 1. In response to the EML Operating Mode Notification frame transmitted by the non-AP MLD, AP2 sends to STA2 another EML Operating Mode Notification frame with the EMLSR Mode subfield in the EML Control field set to 1. After receiving the EML Operating Mode Notification frame from the AP MLD, the non-AP MLD transitions into EMLSR mode, and both STA1 and STA2 transition into listening mode.

Enhanced Multi-Link Multi-Radio (EMLMR) operation is another mode of operation newly defined in the IEEE 802.11be specification. With the EMLMR mode of operation, it is possible for a multi-link device with multiple radios to move transmit (TX)/receive (RX) chains from one link (for example, the first link) to another link (for example, the second link) of the same MLD, essentially increasing the spatial stream capability of the second link.

According to the current 802.11be specification, the procedure for a non-AP MLD's transitioning into the EMLMR mode is quite similar to the procedure for transitioning into the EMLSR mode. According to current 802.11be specifications, if a non-AP MLD intends to operate in the EMLMR mode with its associated AP MLD, a STA affiliated with the non-AP MLD sends an EML Operating Mode Notification frame to its associated AP affiliated with the AP MLD, where the EMLMR Mode subfield in the EML Control field in the EML Operating Mode Notification frame is set to 1 (and the EMLSR Mode in the same frame is set to 0). Upon receiving the EML Operating Mode Notification frame from the non-AP MLD, the AP MLD can send, on any enabled link between the AP MLD and the non-AP MLD, another EML Operating Mode Notification frame, where the EMLMR Mode subfield in the EML Control field in the EML Operating Mode Notification frame is set to 1. The AP affiliated with the AP MLD is expected to send the EML Operating Mode Notification frame in response to the EML Operating Mode Notification frame sent by an STA affiliated with the non-AP MLD within the timeout interval indicated in the Transition Timeout subfield in EML Capabilities subfield in the Basic Variant Multi-Link element that is most recently exchanged between the AP MLD and the non-AP MLD. The non-AP MLD transitions to the EMLMR mode immediately after receiving the EML Operating Mode Notification frame with the EMLMR Mode subfield in the EML Control field set to 1 from an AP affiliated with the AP MLD or immediately after the timeout interval indicated in the Transition Timeout subfield in the EML Capabilities field in the Basic Variant Multi-Link element elapses after the end of the last PPDU contained in the EML Operating Mode Notification frame transmitted by the non-AP MLD, whichever occurs first. The following are some of the steps for operating in the EMLMR mode:
After the non-AP MLD transitions into the EMLMR mode, it is the AP MLD that sends the Initial Frame to the non-AP MLD. The subsequent EMLMR frame exchanges occur on the link on which the AP MLD sends the Initial Frame.
According to the current specification, the initial frame can be any frame that is sent by the AP MLD to the non-AP MLD as the first frame after the non-AP MLD transitions into the EMLMR mode.
According to the current specification, the AP MLD, for EMLMR frame exchanges, shall select one of the links that are included as the EMLMR links.
After the AP MLD sends the initial frame on a link, the non-AP MLD is able to operate on that link with maximum spatial stream as indicated by the values in the EMLMR Rx NSS and EMLMR Tx NSS subfields in the EML Capabilities subfield of the Common Info field of the Basic Multi-Link element.
Immediately after the EMLMR frame exchange sequence is complete, the STAs affiliated with the AP MLD go back to operate with the per-link spatial stream capability.

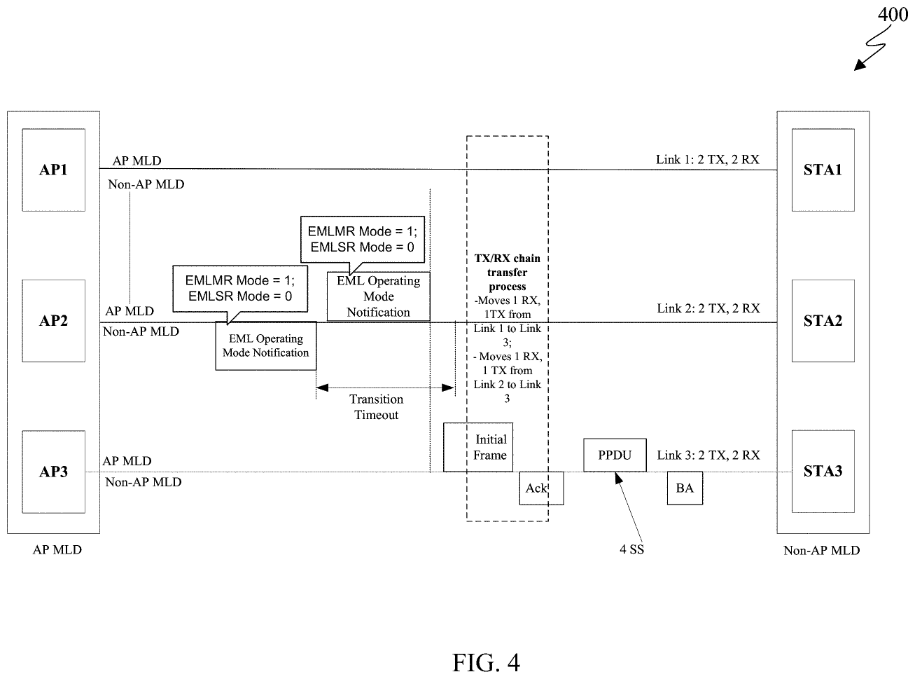

FIG. 4 illustrates an example of a procedure 400 for the EMLMR mode of operation according to embodiments of the present disclosure. The embodiment of the procedure 400 for the EMLMR mode of operation shown in FIG. 4 is for illustration only. Other embodiments of the procedure 400 for the EMLMR mode of operation could be used without departing from the scope of this disclosure.

As illustrated in FIG. 4, the AP MLD has three affiliated APs: AP1 operating on the 2.4 GHz band, AP2 operating on the 5 GHz band, and AP3 operating on the 6 GHz band. The non-AP MLD has three affiliated STAs: STA1 operating on the 2.4 GHz band, STA2 operating on the 5 GHz band, and STA3 operating on the 6 GHz band. Three links are established between the AP MLD and the non-AP MLD: Link 1 between AP1 and STA1, Link 2 between AP2 and STA2, and Link 3 between AP3 and STA3. The non-AP MLD is a multi-radio non-AP MLD, where STA1, STA2, and STA3 each have two transmit chains and two receive chains. Both the AP MLD and the non-AP MLD support the EMLMR mode of operation. The non-AP MLD lists all three links, Link 1, Link 2, and Link 3, as the EMLMR links. In the Basic Multi-Link element exchanged between the AP MLD and the non-AP MLD, the EML Capabilities Present subfield is set to 1, and both the EMLMR Rx NSS and EMLME Tx NSS subfields in the EML Capabilities subfield is set to the value of 4. At one point of time of operation, the non-AP MLD intends to enter into the EMLMR mode and sends an EML Operating Mode Notification frame to the AP MLD on Link 2. In that EML Operating Mode Notification frame, the EMLMR Mode subfield in the EML Control field is set to 1 and the EMLSR Mode subfield in the EML Control field is set to 0. Upon receiving the EML Operating Mode Notification frame on Link 2, AP2 affiliated with the AP MLD sends, in response, another EML Operating Mode Notification frame to the non-AP MLD on Link 2 and sets the EMLMR Mode subfield in the EML Control field to 1 and the EMLSR Mode subfield in the EML Control field to 0 in the EML Operating Mode Notification frame. Upon receiving the EML Operating Mode Notification frame from the AP MLD, which is transmitted before the timeout timer indicated in the Transition Timeout subfield in the EML Capabilities subfield in the Basic Multi-Link element expires, the non-AP MLD transitions into the EMLMR mode. After the non-AP MLD transitions into EMLMR mode, the AP MLD sends the initial frame on Link 3 to initiate the frame exchanges for EMLMR operation. Upon receiving the initial frame on Link 3, the non-AP MLD—
Transfers 1 transmit chain and 1 receive chain from Link 1 to Link 3
Transfers 1 transmit chain and 1 receive chain from Link 2 to Link 3.

After the transmit and receive chain transfer process is complete, Link 3 now has 4 transmit chains and 4 receive chains. Therefore, STA3 affiliated with the non-AP MLD can now perform transmit and receive operation using 4 spatial streams on Link 3, in accordance with the value set in the EMLMR Rx NSS and EMLMR Tx NSS subfields in the EML Capabilities subfield of the Basic Multi-link element. STA 3 affiliated with the non-AP MLD then sends an Ack frame in response to the initial control frame sent by the AP MLD. Accordingly, the AP MLD performs subsequent PPDU transmission to the non-AP MLD on Link 3 using 4 spatial streams. After the EMLMR frame exchange sequence, STAs affiliated with the non-AP MLD are able to perform based on per-link spatial stream capability.

Target wake time (TWT) is a feature for power management in Wi-Fi (wireless fidelity) networks, which was developed by IEEE 802.11ah and later adopted and modified into IEEE 802.11ax. With TWT operation, it suffices for a STA (station) to only wake up at a pre-scheduled time negotiated with another STA or AP (access point) in the network. In IEEE 802.11ax standards, two types of TWT operation is possible—individual TWT operation and broadcast TWT operation. Individual TWT agreements can be established between two STAs or between a STA and an AP. On the other hand, with broadcast TWT operation, an AP can set up a shared TWT session for a group of STAs.

Restricted TWT (r-TWT) operation is a newly introduced feature in IEEE 802.11be (WiFi 7), which provides more protection for restricted TWT scheduled STAs in order to serve its latency sensitive application in a timely manner. Restricted TWT is based on Broadcast TWT mechanism, however, there are some key characteristics that makes restricted TWT operation an important feature for supporting low-latency applications in next generation WLAN systems.

Various embodiments of the present disclosure recognize that for the EMLMR mode of operation, after the non-AP MLD transitions into the EMLMR mode, by exchanging the EML Operating Mode Notification frame with the associated AP MLD over any enabled link between the AP MLD and the non-AP MLD such that the EMLMR Mode subfield in the EML Control field of the exchanged EML Operating Mode Notification frame is set to 1, the AP MLD sends the initial frame to initiate the EMLMR frame exchanges on any EMLMR links. The subsequent EMLMR frame exchanges occur on the link on which the AP MLD sends the Initial Frame.

Various embodiments of the present disclosure recognize that when a restricted TWT schedule is set up on a link between an AP MLD and a non-AP MLD, the STA affiliated with the non-AP MLD and operating on that link should be able to receive and transmit latency-sensitive traffic during the corresponding restricted TWT SP on that link. However, during the EMLMR mode of operation, only one link among the EMLMR links is able to carry out frame transmission. Hence, how the restricted TWT operation can co-exist with EMLMR mode of operation is not clear.

Accordingly, various embodiments of the present disclosure provide mechanisms and frameworks for r-TWT operation in conjunction with EMLMR operation.

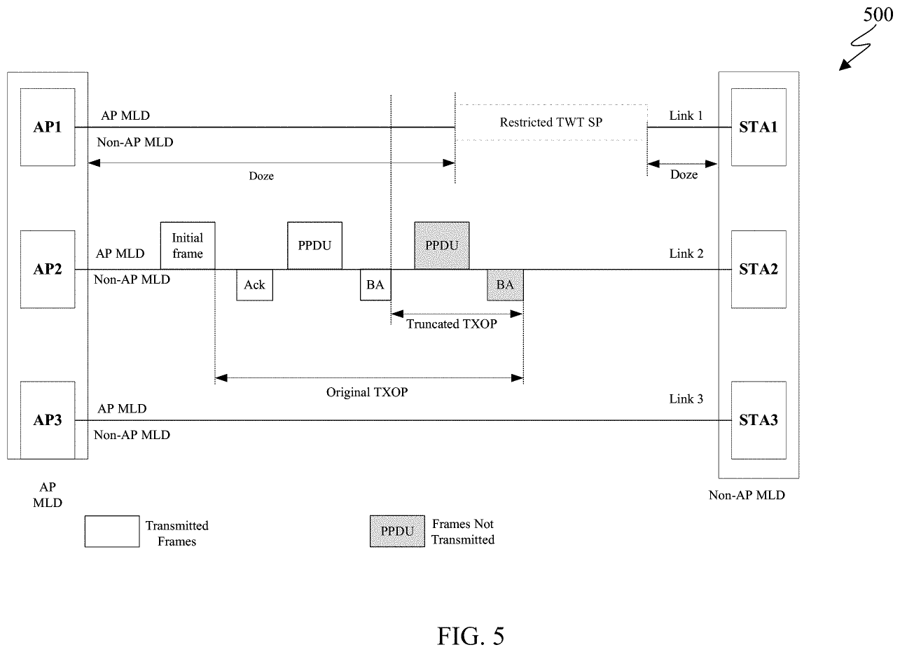

FIG. 5 illustrates an example of ending TXOP on an EMLMR link before a r-TWT SP starts on another EMLMR link 500 according to embodiments of the present disclosure. The embodiment of the example of ending TXOP on an EMLMR link before a r-TWT SP starts on another EMLMR link 500 shown in FIG. 5 is for illustration only. Other embodiments of the example of ending TXOP on an EMLMR link before a r-TWT SP starts on another EMLMR link 500 could be used without departing from the scope of this disclosure.

As illustrated in FIG. 5, according to one embodiment, when a non-AP MLD is operating in EMLMR mode with its associated AP MLD, and an AP affiliated with the AP MLD and operating on one of the EMLMR links (the first link) between the AP MLD and the non-AP MLD is the TXOP holder on that link, if an r-TWT schedule is established on another EMLMR link (the second link) between the same AP MLD and the non-AP MLD, then the AP affiliated the AP MLD and operating on the first link ends its TXOP before the r-TWT SP starts on the second link.

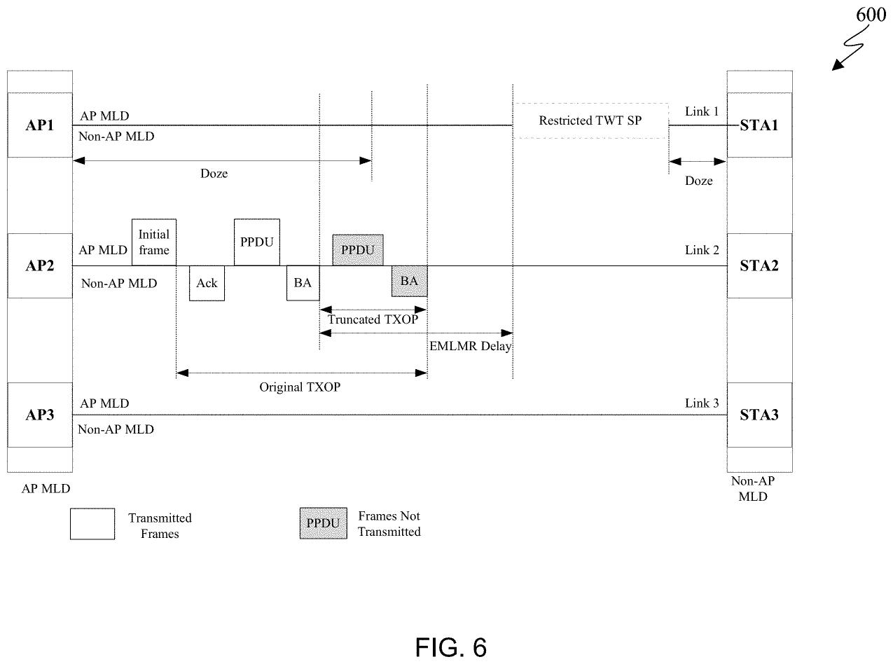

FIG. 6 illustrates an example of ending TXOP on an EMLMR link an EMLMR delay amount of time before the r-TWT SP starts on another EMLMR link 600 according to embodiments of the present disclosure. The embodiment of the example of ending TXOP on an EMLMR link an EMLMR delay amount of time before the r-TWT SP starts on another EMLMR link 600 shown in FIG. 6 is for illustration only. Other embodiments of the example of ending TXOP on an EMLMR link an EMLMR delay amount of time before the r-TWT SP starts on another EMLMR link 600 could be used without departing from the scope of this disclosure.

As illustrated in FIG. 6, according to another embodiment, in the above-mentioned scenario, the TXOP on the first link is ended at least a threshold amount of time before the r-TWT SP starts at the second link. According to one embodiment, this threshold value can be set as the value indicated in the EMLMR Delay subfield in the EML Capabilities subfield.

According to one embodiment, when a non-AP MLD is operating in EMLMR mode with its associated AP MLD and a STA affiliated with the non-AP MLD and operating on one of the EMLMR links (the first link) between the AP MLD and the non-AP MLD is the TXOP holder on that link, if an r-TWT schedule is established on another EMLMR link (the second link) between the same AP MLD and the non-AP MLD, then the STA affiliated the non-AP MLD and operating on the first link ends its TXOP before the r-TWT SP starts on the second link. According to another embodiment, in the above-mentioned scenario, the TXOP on the first link is ended at least a threshold amount of time before the r-TWT SP starts at the second link. According to one embodiment, this threshold value can be set as the value indicated in the EMLMR Delay subfield in the EML Capabilities subfield.

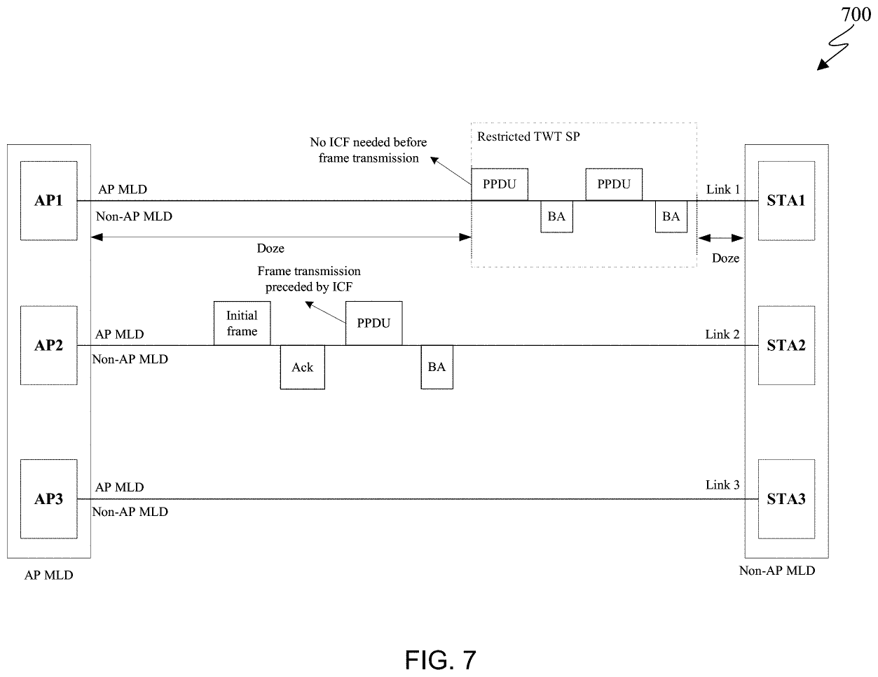

FIG. 7 illustrates an example of frame transmission with EMLMR operation during r-TWT SP without the need for initial control frame (ICF) transmission 700 according to embodiments of the present disclosure. The embodiment of the example of frame transmission with EMLMR operation during r-TWT SP without the need for initial control frame (ICF) transmission 700 shown in FIG. 7 is for illustration only. Other embodiments of the example of frame transmission with EMLMR operation during r-TWT SP without the need for initial control frame (ICF) transmission 700 could be used without departing from the scope of this disclosure.

As illustrated in FIG. 7, according to one embodiment, when a non-AP MLD is operating in EMLMR mode with an AP MLD and an r-TWT schedule is established on one of the EMLMR links between the AP MLD and the non-AP MLD, then an AP affiliated with the AP MLD may initiate a frame exchange during the r-TWT SP on that link without transmitting the initial frame with the padding requirement for EMLMR operation to the r-TWT scheduled STA affiliated with the non-AP MLD and operating on that link.

According to one embodiment, when a non-AP MLD is operating in EMLMR mode with an AP MLD, after the initial frame exchange on any of the EMLMR links, the non-AP MLD moves all the transmit and receive chains from other EMLMR links to the link on which the initial frame exchange occurs. According to another embodiment, the non-AP MLD moves only the needed number of transmit and receive chains to the link on which the initial frame exchange has occurred such that it satisfies the EMLMR receive spatial stream requirement and EMLMR transmit spatial stream requirement announced in the EML Control field by the non-AP MLD.

According to one embodiment, when a non-AP MLD is operating in EMLMR mode with an AP MLD and an r-TWT schedule is established on one of the EMLMR links between the AP MLD and the non-AP MLD, then an AP affiliated with the AP MLD may initiate a frame exchange on an EMLMR link that is different than the one on which the r-TWT schedule is established.

According to one embodiment, when a non-AP MLD is operating in EMLMR mode with an AP MLD and an r-TWT schedule is established on one of the EMLMR links (the first link) between the AP MLD and the non-AP MLD, if the AP MLD sends the initial frame on another EMLMR link (the second link) such that the EMLMR frame exchange on the second link overlaps in time with the r-TWT SP on the first link, then, while moving the transmit and receive chains upon receiving the initial frame on the second link, the non-AP MLD leaves at least one transmit chain and one receive chain on the first link so that the STA affiliated with the non-AP MLD and operating on the first link, can perform frame exchanges during the r-TWT SP with the corresponding AP affiliated with the AP MLD and operating on the first link using at least one spatial stream. According to another embodiment, in such scenario, while moving the transmit and receive chains upon receiving the initial frame on the second link, the non-AP MLD does not remove any transmit and receive chain from the first link so that the STA affiliated with the non-AP MLD and operating on the first link, can perform frame exchanges during the r-TWT SP with the corresponding AP affiliated with the AP MLD and operating on the first link using per link spatial stream capability.

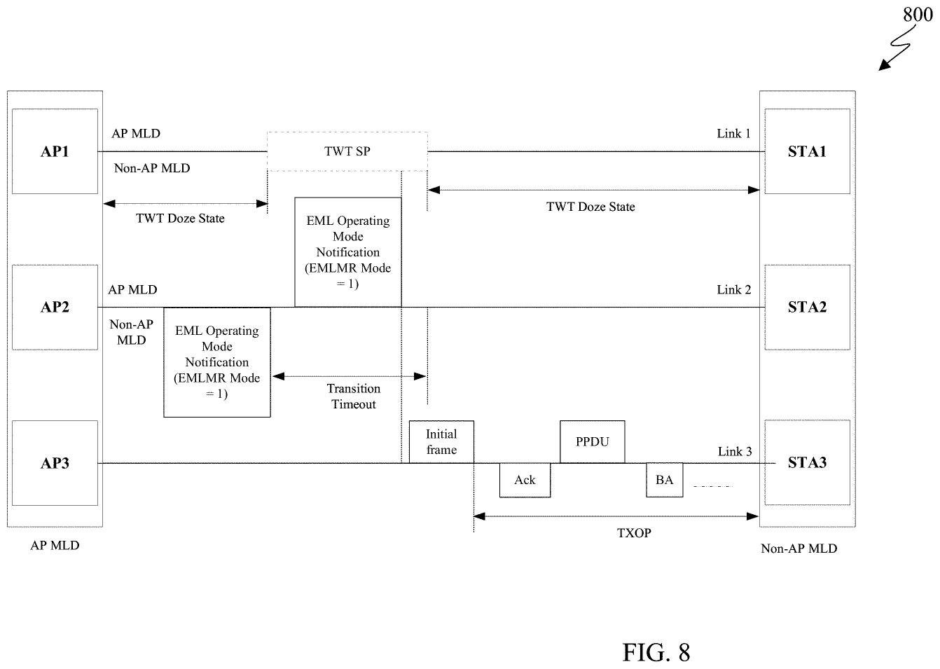

FIG. 8 illustrates an example of avoiding EMLMR initial frame transmission on a link due to too short of TWT SP remaining 800 according to embodiments of the present disclosure. The embodiment of the example of avoiding EMLMR initial frame transmission on a link due to too short of TWT SP remaining 800 shown in FIG. 8 is for illustration only. Other embodiments of the example of avoiding EMLMR initial frame transmission on a link due to too short of TWT SP remaining 800 could be used without departing from the scope of this disclosure.

As illustrated in FIG. 8, according to one embodiment, when a non-AP MLD is operating in EMLMR mode with an AP MLD and an r-TWT schedule is established on one of the EMLMR links (the first link) between the AP MLD and the non-AP MLD, then the AP MLD does not send the EMLMR initial frame on the first link during the doze state duration of the r-TWT schedule on the first link. According to another embodiment, for this scenario, then the AP MLD does not send the EMLMR initial frame on the first link even during the TWT SP duration of the r-TWT schedule on the first link if the AP MLD deems that the remaining time in the r-TWT SP is not sufficient for a complete frame exchange sequence.

In FIGS. 8, AP1, AP2, and AP3 are three APs affiliated with the AP MLD. Also, STA1, STA2, and STA3 are three non-AP STAs affiliated with the non-AP MLD. Three links are set up between the AP MLD and the non-AP MLD—Link 1 between AP1 and STA1, Link 2 between AP2 and STA2, and Link 3 between AP3 and STA3. In this illustration, Link 1, Link 2, and Link 3 are enabled links. An r-TWT schedule is established on Link 1. Now, the non-AP MLD intends to transition to EMLMR mode, and accordingly, STA2 sends to AP2 over Link 2 an EML Operating Mode Notification frame with EMLMR Mode subfield in EML Control field set to 1. In the transmitted EML Operating Mode Notification frame, the non-AP MLD lists all three links as the EMLMR links. In response to the EML Operating Mode Notification frame transmitted by the non-AP MLD, AP2 sends to STA2 another EML Operating Mode Notification frame with EMLMR Mode subfield in EML Control field set to 1. At the end of EML Operating Mode Notification frame received from the AP MLD, STA1 is in awake state during the TWT SP based on the TWT agreement or schedule established on that link. After receiving the EML Operating Mode Notification frame from the AP MLD, the non-AP MLD transitions into EMLMR mode. However, as illustrated in FIG. 8, STA1's remaining time in TWT SP is too short and is not sufficient, as deemed by the AP MLD, for completing an intended frame exchange sequence. Accordingly, AP MLD doesn't consider Link 1 as a viable option for frame exchanges under EMLMR operation, and chooses either Link 2 or Link 3 for EMLMR frame exchange sequence (Link 3 chosen for illustration in FIG. 8).

According to one embodiment, when a non-AP MLD is operating in EMLMR mode with an AP MLD and an r-TWT schedule is established on a link (first link), which is not any of the EMLMR links, between the AP MLD and the non-AP MLD, then the EMLMR operation on the EMLMR links can operate independently of the r-TWT operation on the first link.

According to one embodiment, if an r-TWT schedule is established on a link (first link) between an AP MLD and a non-AP MLD, then the non-AP MLD, if it intends to operate in the EMLMR mode, does not include the first link in the EMLMR links as indicated in the EMLMR Link Bitmap subfield of the EML Control field.

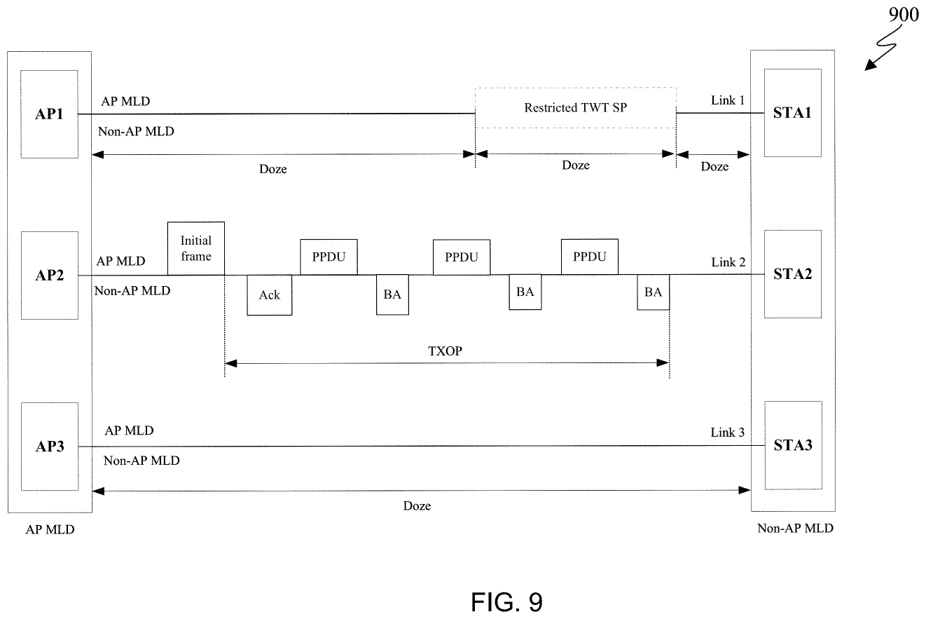

FIG. 9 illustrates an example of the continuation of TXOP on an EMLMR link (Link 2) while another EMLMR link (Link 1) has an r-TWT SP that overlaps in time with the TXOP, where the TIDs negotiated for the r-TWT SP on Link 1 are also mapped on Link 2 900 according to embodiments of the present disclosure. The embodiment of the example of the continuation of TXOP on an EMLMR link (Link 2) while another EMLMR link (Link 1) has an r-TWT SP that overlaps in time with the TXOP, where the TIDs negotiated for the r-TWT SP on Link 1 are also mapped on Link 2 900 shown in FIG. 9 is for illustration only. Other embodiments of the example of the continuation of TXOP on an EMLMR link (Link 2) while another EMLMR link (Link 1) has an r-TWT SP that overlaps in time with the TXOP, where the TIDs negotiated for the r-TWT SP on Link 1 are also mapped on Link 2 900 could be used without departing from the scope of this disclosure.

As illustrated in FIG. 9, according to one embodiment, for the scenario where a TWT agreement or a TWT schedule is established on a link between an AP MLD and a non-AP MLD, if the non-AP MLD transitions into EMLMR mode of operation, the link over which the TWT agreement or schedule has been established is exempt from the requirement of being in listening mode if the STA affiliated with the non-AP MLD operating on that link is scheduled to be in doze state according to the established TWT agreement or TWT schedule. According to this embodiment, the AP MLD does not send the EMLSR initial control frame (MU-RTS, BSRP etc.) over the link on which the associated STA is supposed to be in doze state based on the existing TWT agreement or schedule established on that link.

According to another embodiment, for the scenario where a non-AP MLD is operating in EMLMR mode and a frame exchange sequence is taking place on one of the enabled links (say, the second link) between the AP MLD and the non-AP MLD, if a TWT schedule/agreement is set up over another link (say, the first link) between the same AP MLD and the non-AP MLD, where the TWT SP on the first link overlaps in time with the frame exchange sequence taking place on the second link, then the AP MLD can continue with the frame exchange sequence on the second link if the set of TIDs that are mapped on the first link for the restricted TWT schedule are also mapped on the second link. According to this embodiment, the latency sensitive traffic for the non-AP MLD can be transmitted on the second link and the STA operating on the first link can remain in doze state even during restricted TWT SP.

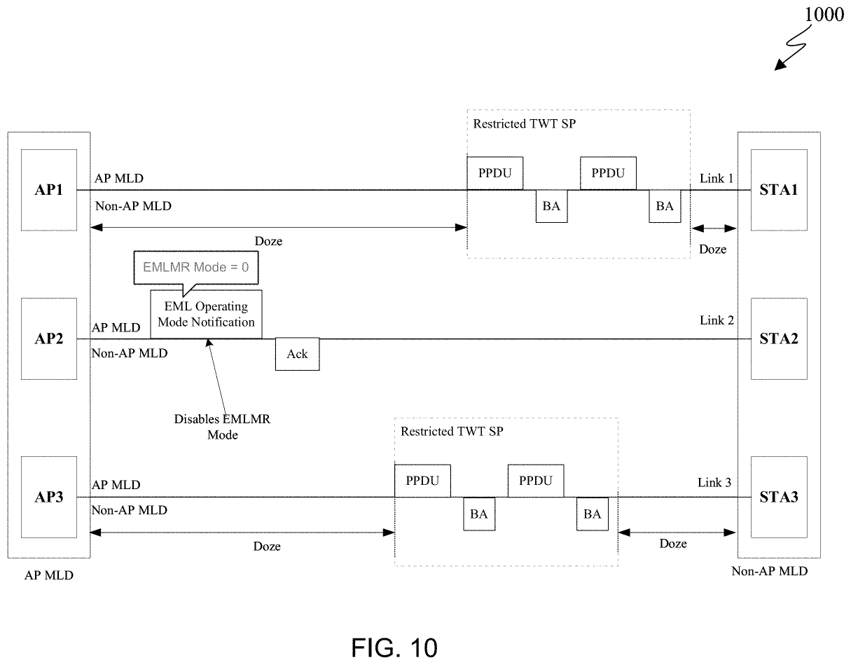

FIG. 10 illustrates an example of disabling the EMLMR mode before overlapping r-TWT SP 1000 according to embodiments of the present disclosure. The embodiment of the example of disabling the EMLMR mode before overlapping r-TWT SP 1000 shown in FIG. 10 is for illustration only. Other embodiments of the example of disabling the EMLMR mode before overlapping r-TWT SP 1000 could be used without departing from the scope of this disclosure.

As illustrated in FIG. 10, according to one embodiment, when a non-AP MLD is operating in EMLMR mode with an AP MLD and multiple r-TWT schedules are established on multiple links between the AP MLD and the non-AP MLD, and if those links are also included in the EMLMR links and if the r-TWT SP on one link (the first link) overlaps, in time, with the r-TWT SP on another link (the second link), then the non-AP MLD disables the EMLMR mode before the overlapping TWT SP starts on either of the links. According to another embodiment, the AP MLD can also disable or enable an EMLMR mode. According to yet another embodiment, in the above-mentioned scenario, both of the links operate with per-link spatial stream capability during the overlapping r-TWT SP.

According to another embodiment, when a non-AP MLD is operating in EMLMR mode with an AP MLD and multiple r-TWT schedules are established on multiple links between the AP MLD and the non-AP MLD, and if those links are also included in the EMLMR links and if the r-TWT SP on one link (the first link) overlaps, in time, with the r-TWT SP on another link (the second link), then either of the two links is prioritized for EMLMR frame exchanges. According to another embodiment, in the scenario stated above, while prioritizing one link over the other, at least one transmit chain and one receive chain is left at the deprioritized link.

According to another embodiment, in the above scenario, the link prioritization can be made based on latency-sensitiveness of the corresponding traffic. For example, according to one embodiment, the link where the traffic with higher priority TIDs are intended for transmission during the TWT SP will be chosen for transmitting the EMLMR initial frame by the AP. If both TWT schedules on the two links are restricted TWT schedules, according to another embodiment, the link corresponding to the r-TWT schedule for which higher priority TIDs are negotiated according to the r-TWT setup procedure is prioritized over the other. According to another embodiment, if one link has individual TWT agreement or broadcast TWT schedule that is not an r-TWT schedule, and the other link has a restricted TWT schedule, then the link with the restricted TWT schedule is prioritized in such scenario.

For the scenario described in one or more of the previous embodiments, according to one embodiment, the prioritization means that during the overlapping r-TWT SP on the two links, EMLMR frame exchange can happen on the prioritized link with the transmit and receive spatial streams as announced in the EML Control field by the non-AP MLD whereas no frame exchange happens on the deprioritized link. According to another embodiment, prioritization means that during the overlapping r-TWT SP on the two links, EMLMR frame exchange can happen on the prioritized link with the transmit and receive spatial streams as announced in the EML Control field by the non-AP MLD whereas frame exchange with a single transmit and/or receive spatial stream can happen on the deprioritized link. According to another embodiment, prioritization means that during the overlapping r-TWT SP on the two links, EMLMR frame exchange can happen on the prioritized link with the transmit and receive spatial streams as announced in the EML Control field by the non-AP MLD whereas frame exchange on the deprioritized link can happen based on per-link spatial stream capability.

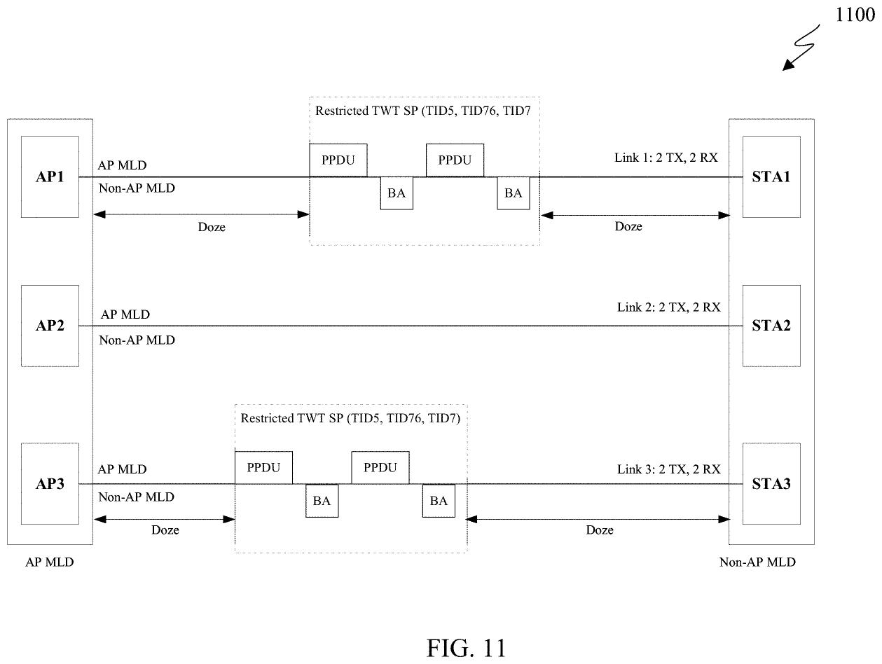

FIG. 11 illustrates another example of disabling the EMLMR mode before overlapping r-TWT SP 1100 according to embodiments of the present disclosure. The embodiment of the example of disabling the EMLMR mode before overlapping r-TWT SP 1100 shown in FIG. 11 is for illustration only. Other embodiments of the example of disabling the EMLMR mode before overlapping r-TWT SP 1100 could be used without departing from the scope of this disclosure.

As illustrated in FIG. 11, when a non-AP MLD is operating in EMLMR mode with an AP MLD and multiple r-TWT schedules are established on multiple links between the AP MLD and the non-AP MLD such that same set of TIDs are negotiated for both r-TWT schedules on the two links, and if those links are also included in the EMLMR links and if the r-TWT SP on one link (the first link) overlaps, in time, with the r-TWT SP on another link (the second link), then according to one embodiment, during the overlapping r-TWT SPs on the two links, frame exchange can happen on both links on a per link spatial stream capability basis. In such case, the AP MLD may not need to send EMLMR initial frame on either of the links. In FIG. 11, Link 1 and Link 3 both have overlapping r-TWT for TIDs 5-7. During the frame exchanges within the r-TWT SP on the corresponding link, the frame exchange can happen on a per-link spatial stream capability basis, which is 2 TX, 2 RX on both links in this example.

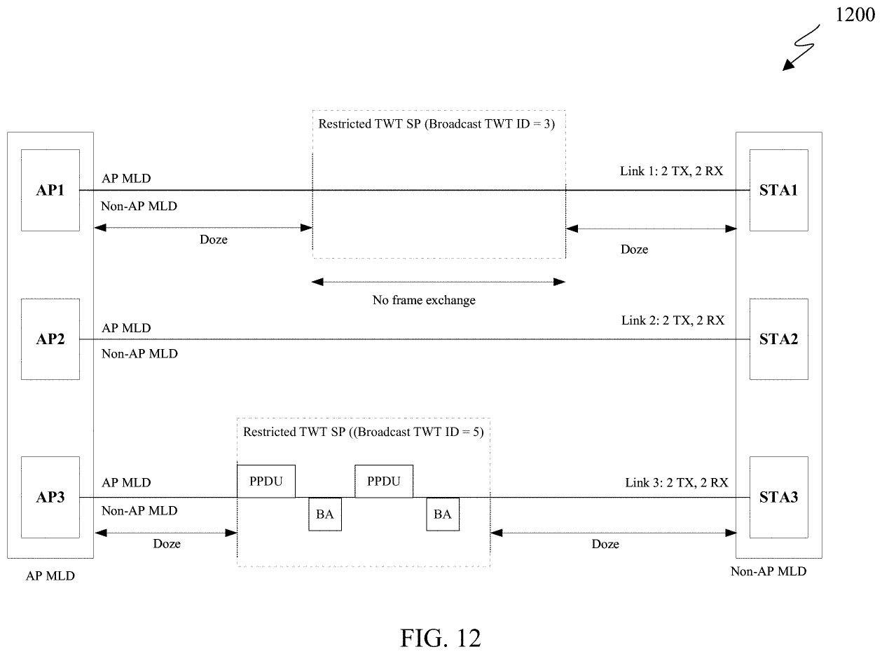

FIG. 12 illustrates an example of r-TWT SP prioritization based on broadcast TWT ID during the EMLMR mode of operation 1200 according to embodiments of the present disclosure. The embodiment of the example of r-TWT SP prioritization based on broadcast TWT ID during the EMLMR mode of operation 1200 shown in FIG. 12 is for illustration only. Other embodiments of the example of r-TWT SP prioritization based on broadcast TWT ID during the EMLMR mode of operation 1200 could be used without departing from the scope of this disclosure.

As illustrated in FIG. 12, according to another embodiment, for the above scenario, one link is prioritized over the other and the prioritization is made based on the broadcast TWT ID of the two schedules on the two links. For example, the link with the r-TWT schedule with the higher (or lower) broadcast TWT ID can be prioritized. In such case, the AP MLD may not need to send EMLMR initial frame on the prioritized link.

According to another embodiment, the prioritization can be made based on the number of member STAs of the respective r-TWT schedules. For example, the link with the r-TWT schedule that has lower (or higher) number of r-TWT memberships can be prioritized. In such case, the AP MLD sends the initial frame for the frame exchange sequence to the prioritized link since the non-AP MLD is not aware of the schedule's load.

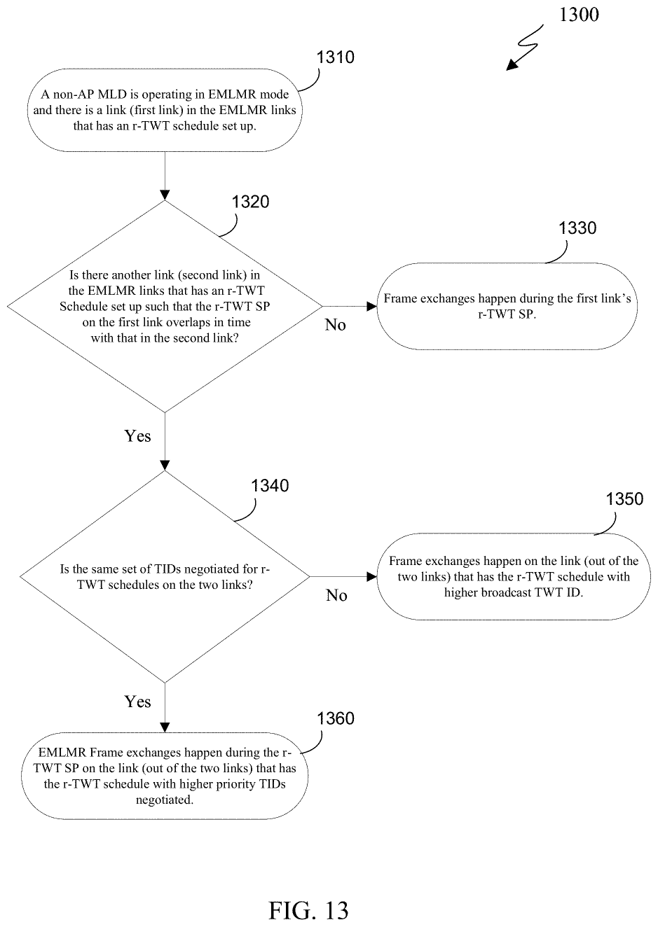

FIG. 13 illustrates a flowchart of a method 1300 of EMLMR operation with multiple r-TWT schedules established on multiple EMLMR links according to embodiments of the present disclosure. The embodiment of the method 1300 of EMLMR operation with multiple r-TWT schedules established on multiple EMLMR links shown in FIG. 13 is for illustration only. Other embodiments of the method 1300 of EMLMR operation with multiple r-TWT schedules established on multiple EMLMR links could be used without departing from the scope of this disclosure.

As illustrated in FIG. 13, the method 1300 begins at step 1310, where a non-AP MLD is operating in EMLMR mode and there is a link (first link) in the EMLMR links that has an r-TWT schedule set up. At step 1320, a determination is made whether there is another link (second link) in the EMLMR links that has an r-TWT Schedule set up such that the r-TWT SP on the first link overlaps in time with that in the second link. If not, then at step 1330, frame exchange happens during the first link's r-TWT SP. If there is another link in the EMLMR links that has an r-TWT Schedule set up such that the r-TWT SP on the first link overlaps in time with that in the second link, then at step 1340, a determination is made whether the same set of TIDs is negotiated for r-TWT schedules on the two links. If not, then at step 1350, frame exchanges happen on the link (out of the two links) that has the r-TWT schedule with higher broadcast TWT ID. If the same set of TIDs is negotiated for r-TWT schedules on the two links, then at step 1360, EMLMR frame exchanges happen during the r-TWT SP on the link (out of the two links) that has the r-TWT schedule with higher priority TIDs negotiated.

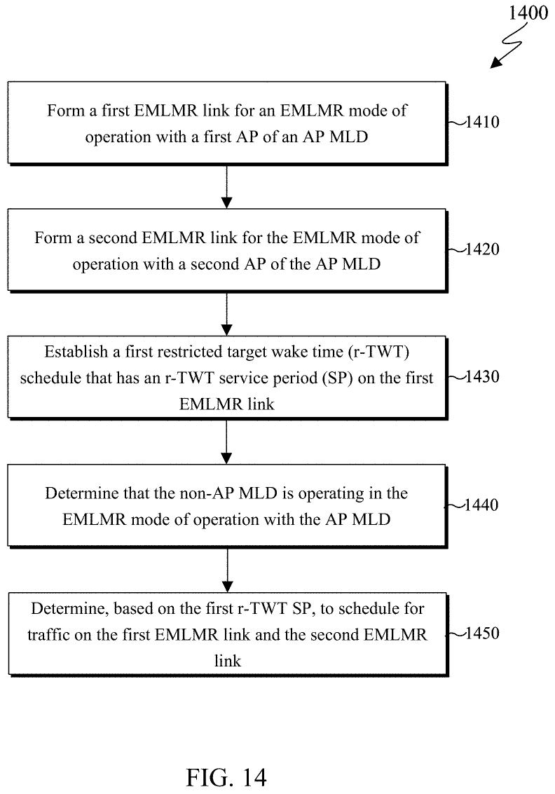

FIG. 14 illustrates a flowchart of a method 1400 for wireless communication performed by a non-AP MLD according to embodiments of the present disclosure. The embodiment of the method 1400 for wireless communication performed by a non-AP MLD shown in FIG. 14 is for illustration only. Other embodiments of the method 1400 for wireless communication performed by a non-AP MLD could be used without departing from the scope of this disclosure.

As illustrated in FIG. 14, the method 1400 begins at step 1410, where a first EMLMR link for an EMLMR mode of operation with a first AP of an AP MLD is formed. At step 1420, a second EMLMR link for the EMLMR mode of operation with a second AP of the AP MLD is formed. At step 1430, a first restricted target wake time (r-TWT) schedule that has an r-TWT service period (SP) on the first EMLMR link is established. At step 1440, a determination is made that the non-AP MLD is operating in the EMLMR mode of operation with the AP MLD. At step 1450, a determination is made, based on the first r-TWT SP, to schedule for traffic on the first EMLMR link and the second EMLMR link.

In one embodiment, a TXOP is established on the second EMLMR link, the TXOP and the first r-TWT SP having an overlapping portion, and, based on the TXOP and the first r-TWT SP, the non-AP MLD determines to schedule traffic on the first EMLMR link and the second EMLMR link such that the STA operating on the second EMLMR link ends the TXOP before the first r-TWT SP starts on the first EMLMR link.

In one embodiment, a TXOP is established on the second EMLMR link, the TXOP and the first r-TWT SP having an overlapping portion, and, based on the TXOP and the first r-TWT SP, the non-AP MLD determines scheduling traffic on the first EMLMR link and the second EMLMR link such that the TXOP is ended at least a threshold amount of time before the first r-TWT SP starts on the first EMLMR link.

In one embodiment, the non-AL MLD determines scheduling traffic on the first and second links such that a frame exchange during the first r-TWT SP on the first EMLMR link is initiated by the first AP without the first STA receiving an initial frame with a padding requirement for the EMLMR mode of operation from the first AP.

In one embodiment, the non-AP MLD determines scheduling traffic on the first and second links such that the first STA does not receive an EMLMR initial frame on the first link during a doze state duration of the first r-TWT SP on the first link.

In one embodiment, a second r-TWT SP is established on the second EMLMR link, the first r-TWT SP and the second r-TWT SP having an overlapping portion, and the non-AP MLD determines scheduling traffic on the first EMLMR link and the second EMLMR link such that the EMLMR mode of operation is disabled before the overlapping portion starts on the first EMLMR link or the second EMLMR link.

In one embodiment, a second r-TWT SP is established on the second EMLMR link, the first r-TWT SP and the second r-TWT SP having an overlapping portion, the first r-TWT SP having an associated set of traffic identifiers (TIDs) and the second r-TWT SP having the set of TIDs, and the non-AP MLD determines scheduling traffic on the first EMLMR link and the second EMLMR link such that frame exchange occurs on both the first EMLMR link and the second EMLMR link on a per link spatial capability basis.

In one embodiment, a second r-TWT SP is established on the second EMLMR link, the first r-TWT SP and the second r-TWT SP having an overlapping portion, the first r-TWT SP having an associated set of traffic identifiers (TIDs) and the second r-TWT SP having another set of TIDs, and the non-AP MLD determines scheduling traffic on the first EMLMR link and the second EMLMR link such that one of the first EMLMR link and the second EMLMR link is prioritized over another of the first EMLMR link and the second EMLMR link based on a TWT ID.

The above flowcharts illustrate example methods that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) multi-link device (MLD) comprising:
stations (STAs) comprising transceivers, respectively, a first of the STAs configured to form a first enhanced multi-link multi-radio (EMLMR) link for an EMLMR mode of operation with a first AP of an AP MLD, and a second of the STAs configured to form a second EMLMR link for the EMLMR mode of operation with a second AP of the AP MLD, wherein a first restricted target wake time (r-TWT) schedule that has a first r-TWT service period (SP) is established on the first EMLMR link; and
a processor operably coupled to the transceivers, the processor configured to:
determine that the non-AP MLD is operating in the EMLMR mode of operation with the AP MLD, and
based on the first r-TWT SP, determine scheduling for traffic on the first EMLMR link and the second EMLMR link.

2. The non-AP MLD of claim 1, wherein:
a transmission opportunity (TXOP) is established on the second EMLMR link, the TXOP and the first r-TWT SP having an overlapping portion, and
the processor is further configured, based on the TXOP and the first r-TWT SP, to determine scheduling traffic on the first EMLMR link and the second EMLMR link such that the STA operating on the second EMLMR link ends the TXOP before the first r-TWT SP starts on the first EMLMR link.

3. The non-AP MLD of claim 1, wherein:
a transmission opportunity (TXOP) is established on the second EMLMR link, the TXOP and the first r-TWT SP having an overlapping portion, and
the processor is further configured, based on the TXOP and the first r-TWT SP, to determine scheduling traffic on the first EMLMR link and the second EMLMR link such that the TXOP is ended at least a threshold amount of time before the first r-TWT SP starts on the first EMLMR link.

4. The non-AP MLD of claim 1, wherein the processor is further configured to determine scheduling traffic on the first and second links such that a frame exchange during the first r-TWT SP on the first EMLMR link is initiated by the first AP without the first STA receiving an initial frame with a padding requirement for the EMLMR mode of operation from the first AP.

5. The non-AP MLD of claim 1, wherein the processor is further configured to determine scheduling traffic on the first and second links such that the first STA does not receive an EMLMR initial frame on the first link during a doze state duration of the first r-TWT SP on the first link.

6. The non-AP MLD of claim 1, wherein:
a second r-TWT SP is established on the second EMLMR link, the first r-TWT SP and the second r-TWT SP having an overlapping portion, and
the processor is further configured to determine scheduling traffic on the first EMLMR link and the second EMLMR link such that the EMLMR mode of operation is disabled before the overlapping portion starts on the first EMLMR link or the second EMLMR link.

7. The non-AP MLD of claim 1, wherein:
a second r-TWT SP is established on the second EMLMR link, the first r-TWT SP and the second r-TWT SP having an overlapping portion,
the first r-TWT SP having an associated set of traffic identifiers (TIDs) and the second r-TWT SP having the set of TIDs, and
the processor is further configured to determine scheduling traffic on the first EMLMR link and the second EMLMR link such that frame exchange occurs on both the first EMLMR link and the second EMLMR link on a per link spatial capability basis.

8. The non-AP MLD of claim 1, wherein:
a second r-TWT SP is established on the second EMLMR link, the first r-TWT SP and the second r-TWT SP having an overlapping portion,
the first r-TWT SP having an associated set of traffic identifiers (TIDs) and the second r-TWT SP having another set of TIDs, and
the processor is further configured to determine scheduling traffic on the first EMLMR link and the second EMLMR link such that one of the first EMLMR link and the second EMLMR link is prioritized over another of the first EMLMR link and the second EMLMR link based on a TWT ID.

9. An access point (AP) multi-link device (MLD) comprising:
APs comprising transceivers, respectively, a first of the APs configured to form a first enhanced multi-link multi-radio (EMLMR) link for an EMLMR mode of operation with a first station (STA) of a non-AP MLD, and a second of the APs configured to form a second EMLMR link for the EMLMR mode of operation with a second STA of the AP MLD, wherein a first restricted target wake time (r-TWT) schedule that has a first r-TWT service period (SP) is established on the first EMLMR link; and
a processor operably coupled to the transceivers, the processor configured to:
determine that the AP MLD is operating in the EMLMR mode of operation with the non-AP MLD, and
based on the first r-TWT SP, determine scheduling for traffic on the first EMLMR link and the second EMLMR link.

10. The AP MLD of claim 9, wherein:
a transmission opportunity (TXOP) is established on the second EMLMR link, the TXOP and the first r-TWT SP having an overlapping portion, and
the processor is further configured, based on the TXOP and the first r-TWT SP, to determine scheduling traffic on the first EMLMR link and the second EMLMR link such that the STA operating on the second EMLMR link ends the TXOP before the first r-TWT SP starts on the first EMLMR link.

11. The AP MLD of claim 9, wherein:
a transmission opportunity (TXOP) is established on the second EMLMR link, the TXOP and the first r-TWT SP having an overlapping portion, and
the processor is further configured, based on the TXOP and first r-TWT SP, to determine scheduling traffic on the first EMLMR link and the second EMLMR link such that the TXOP is ended at least a threshold amount of time before the first r-TWT SP starts on the first EMLMR link.

12. The AP MLD of claim 9, wherein the processor is further configured to determine scheduling traffic on the first and second links such that a frame exchange during the first r-TWT SP on the first EMLMR link is initiated by the first AP without the first STA receiving an initial frame with a padding requirement for the EMLMR mode of operation from the first AP.

13. The AP MLD of claim 9, wherein the processor is further configured to determine scheduling traffic on the first and second links such that the first AP does not send an EMLMR initial frame on the first link during a doze state duration of the first r-TWT SP on the first link.

14. The AP MLD of claim 9, wherein:
a second r-TWT SP is established on the second EMLMR link, the first r-TWT SP and the second r-TWT SP having an overlapping portion, and
the processor is further configured to determine scheduling traffic on the first EMLMR link and the second EMLMR link such that the EMLMR mode of operation is disabled before the overlapping portion starts on the first EMLMR link or the second EMLMR link.

15. The non-AP MLD of claim 9, wherein:
a second r-TWT SP is established on the second EMLMR link, the first r-TWT SP and the second r-TWT SP having an overlapping portion,
the first r-TWT SP having an associated set of traffic identifiers (TIDs) and the second r-TWT SP having the set of TIDs, and
the processor is further configured to determine scheduling traffic on the first EMLMR link and the second EMLMR link such that frame exchange occurs on both the first EMLMR link and the second EMLMR link on a per link spatial capability basis.

16. The AP MLD of claim 9, wherein:
a second r-TWT SP is established on the second EMLMR link, the first r-TWT SP and the second r-TWT SP having an overlapping portion,
the first r-TWT SP having an associated set of traffic identifiers (TIDs) and the second r-TWT SP having another set of TIDs, and
the processor is further configured to determine scheduling traffic on the first EMLMR link and the second EMLMR link such that one of the first EMLMR link and the second EMLMR link is prioritized over another of the first EMLMR link and the second EMLMR link based on a TWT ID.

17. A method for wireless communication performed by a non-access point (AP) multi-link device (MLD) that comprises stations (STAs), the method comprising:
forming a first enhanced multi-link multi-radio (EMLMR) link for an EMLMR mode of operation with a first AP of an AP MLD;
forming a second EMLMR link for the EMLMR mode of operation with a second AP of the AP MLD;
establishing a first restricted target wake time (r-TWT) schedule that has a first r-TWT service period (SP) on the first EMLMR link;
determining that the non-AP MLD is operating in the EMLMR mode of operation with the AP MLD; and
determining, based on the first r-TWT SP, scheduling for traffic on the first EMLMR link and the second EMLMR link.

18. The method of claim 17, further comprising:
establishing a transmission opportunity (TXOP) on the second EMLMR link, the TXOP and the first r-TWT SP having an overlapping portion; and
determining, based on the TXOP and the first r-TWT SP, scheduling traffic on the first EMLMR link and the second EMLMR link such that the STA operating on the second EMLMR link ends the TXOP before the first r-TWT SP starts on the first EMLMR link.

19. The method of claim 17, further comprising:
establishing a transmission opportunity (TXOP) on the second EMLMR link, the TXOP and the first r-TWT SP having an overlapping portion, and
determining, based on the TXOP and the first r-TWT SP, scheduling traffic on the first EMLMR link and the second EMLMR link such that the TXOP is ended at least a threshold amount of time before the first r-TWT SP starts on the first EMLMR link.

20. The method of claim 19 further comprising determining scheduling traffic on the first and second links such that a frame exchange during the first r-TWT SP on the first EMLMR link is initiated by the first AP without the first STA receiving an initial frame with a padding requirement for the EMLMR mode of operation from the first AP.
